(19) United States
(12) Patent Application Publication
(10) Pub. No.: US 2009/0317356 A1
(43) Pub. Date: Dec. 24, 2009

(54) Composition and method for repelling mammals

(76) Inventor: Michael Allen Casey, Port Washington, NY (US)

Correspondence Address: Michael A. Casey, 128 Luquer Rd., Port Washington, NY, 11050, US

(21) Appl. No.: 12/214,566

(22) Filed: Jun. 21, 2008

(51) Int. Cl. A01N 25/00; A01P 19/00; A01P 17/00

(52) U.S. Cl. 424/84

(57) ABSTRACT

A composition that first attracts then repels mammals, which is delivered via an easy-to-use open container, or on a transportable flat surface. The open container or transportable flat surface holding the composition may be placed near, in or on an object or area to be protected. The composition maintains its effectiveness over an extended period of time, in varying climates and weather conditions.

### CROSS-REFERENCE TO RELATED APPLICATIONS

Not Applicable

### FEDERALLY SPONSORED

Not Applicable

### SEQUENCE LISTING OR PROGRAM

Not Applicable

### BACKGROUND OF THE INVENTION

1. Field of Invention

The present invention relates to compositions which include an attracting component, and a repelling component, as a method for repelling mammals.

2. Prior Art

Various types of repellant compositions are well known in the art. The nature of the repellent composition will vary depending upon the species of animal, bird or insect which it is intended to repel. Many of the known repellants are based on man-made chemicals and for this reason, are not considered desirable for ecological reasons.

Of particular interest is the ability to repel mammals using compositions of extracts of capsaicin derived from plants of the genus capsicum. Capsaicin is an irritant to mammals and in its pure form is repelled by water, colorless, odorless, and is a crystalline to waxy compound. The seeds of capsicum plants are predominantly dispersed by birds, in which capsaicin has analgesic rather than irritant properties. Chili pepper seeds consumed by birds pass through the digestive tract unharmed and will germinate, whereas those consumed by mammals do not germinate. The presence of capsaicin in the fruits therefore protects them from being consumed by mammals. In nature, mammals have a natural tendency to avoid plants that contain capsaicin.

Several compositions and methods to repel animals have been developed to take advantage of the effects that capsaicin has on mammals. U.S. Pat. No. 6,159,474 to Davidson (1998) discloses a mixture that contains active ingredients of black pepper oil, piperine and capsaicin, with the primary deterrent meant to be the smell of the mixture. However, because one of the physical properties of capsaicin is that it is generally odorless, the mammal would first need to be attracted to the mixture, and subsequently ingest it to reinforce the undesirable nature of the mixture. In this embodiment, the main ingredient meant to repel mammals is pepper. It is unknown if the capsaicin plays any role as a deterrent, because the smell of the oil of black pepper and piperine is enough of a deterrent to prevent the mammal from ingesting the substance. The mammal would learn to avoid the substance based on the smell, but not necessarily based on the existence of capsaicin. This mixture is marketed as “Critter Ridder”, and the instructions state that the effectiveness wears off in 30 days and the substance must be reapplied as needed. (The limited effectiveness based on smell is directly stated on the package labeling). The user must also spread the mixture on or around the area to be protected at a rate of 1 pound per 40 square feet. The composition must be accurately weighed, and the area must be accurately measured to apply the correct amount. It is possible that too little will be applied, making the treatment ineffective, or too much will be used which causes waste. In all situations, this composition is meant to repel, and never attract.

U.S. Pat. No. 4,440,783 to Downing, discloses the use of mustard oil with a greater amount of lemon grass oil and other inert materials as a composition to be sprayed on garbage to repel raccoons, dogs and the like. It does not mention the use of capsaicin as an ingredient in the compound. It is surmised that this mixture repels based on the odor of the mixture from the listed test results. The mixture must be applied to the area to be treated, and the effectiveness of this compound will be diminished based on adverse weather conditions including rain, heat or cold. In all situations, this composition is meant to repel, and never attract.

U.S. Pat. No. 6,923,977 by Boyce discloses the use of a mixture of castor oil, habanero pepper extract and white distilled vinegar, to be sprayed onto surfaces or combined with petroleum jelly and applied to surfaces with a brush. This mixture is only meant to repel squirrels. The vinegar is acidic and could affect the finish on the surface where applied, and if mixed with petroleum jelly, the area would need to be thoroughly cleaned before repainting. Though useful, these ingredients would be inconvenient over time based on the additional cleanup required for the areas where applied. In all situations, this composition is meant to repel, and never attract.

U.S. Pat. No. 5,698,191 by Wiersma discloses a composition comprising capsicum oleoresin and saponin (capsaicin and “soap”) which should be applied to, or incorporated into the object to be protected. It is stated that the carrier comprises water, or is an oil-in-water emulsion, or is a fatty oil liquid at 25 degrees C. (77 degrees F.). This composition must be applied to the object to be protected, and must be dried onto the surface for which is has been applied, or incorporated into another medium and applied to a surface. In this embodiment, the repellant must be dried to become effective, which may not be possible in a humid environment, or during rainy weather. In all situations, this composition is meant to repel, and never attract.

U.S. Pat. No. 5,705,199 by Maish discloses a composition comprising an attracting agent, and a repelling agent. It is strictly meant for underground application, and would not be suitable for above-ground use to repel mammals from gardens, trash cans or the like. This composition is acidic, and is meant to become more acidic with the addition of ground moisture, and is meant solely as a lawn treatment. In addition, it does not have a capsaicin component. In extremely dry climates, this would be ineffective, because the moisture would be absent, or in an amount so small, that the composition would be rendered useless.

While these formulations and methods may be suitable for the particular purposes described, they would not be as suitable for the purposes of the present invention as disclosed hereafter.

### SUMMARY

The present invention provides a composition of an attracting agent mixed with a repelling agent, contained in an open-ended container. The composition in the open-ended container or cup, is placed near the object from which mammals are to be repelled, or on the object from which mammals are to be repelled. The composition contained in the cup will first attract then repel the mammal. The purpose of this invention is to repel mammals, like raccoons, dogs, etc., from things like garbage cans, gardens, expensive flora and the like. The mammal will be attracted to the composition, taste it, and then be repelled by the irritant in the mixture. It should be noted that the mixture is all natural, and will not permanently or seriously harm the mammal.

### DETAILED DESCRIPTION

The repelling agent can be any compound that is an irritant to the mammal to be repelled. In one embodiment, the repelling agent is a capsaicin-based compound, which produces a mixture of sufficient Scoville rating to repel mammals. (The Scoville scale is a measure of the “hotness” or piquancy of a chili pepper). It is important that the mammal be attracted to this mixture so that it will taste the composition, then subsequently be repelled. The capsaicin in the mixture is the repelling agent, because it is an irritant to mucus membranes in mammals.

The capsaicin-based ingredient of the repellent composition of this invention is an extract from plants of the Capsicum family, such as Capsicum annum or Capsicum frutescens. Available sources are commonly known as paprika, red pepper, chili pepper and chili powder. Ground red pepper is sometimes referred to as “cayenne”, to signify a ground red pepper product of extremely high heat. However, the word “cayenne” does not carry an industry standard of heat level nor is it a particular type of Capsicum. Heat levels can be expressed in ASTA (American Spice Trade Association) units equal to parts per million of capsaicin measured by high pressure liquid chromatography, or in Scoville thermal heat units (SU) whereby 1ASTA unit=15 SU. Ground red pepper typically ranges from 300 to 1,000 ASTA Heat Units corresponding to 4,500 to 60,000 SU.

The composition of the mixture is typically between 50.00-99.99% attracting agent and 0.01-50.00% capsaicin, so as to produce a sufficient Scoville rating to repel mammals. The resultant Scoville rating typically should be at least 2,000 Scoville units (SU), with a preferred rating of 30,000 (SU) or higher.

The composition may be prepared by combining the ingredients in any order found convenient. In one embodiment, the attracting agent is peanut butter, and the capsaicin compound is ground red pepper, or “cayenne” pepper. These are combined and mixed to produce a uniform consistency, then placed in a small cup, paper plate, etc., so as to easily transport the mixture to the object to be protected. The total amount of the required “dose” is typically one teaspoon. The mixture in the open-ended container may then be placed on the object, or on the ground next to the object, where the mammal would typically forage. It is important to use an open-ended container to hold the mixture, because it provides for easy application, prolongs the time the mixture is effective, and provides for easy cleanup. In addition, the mixture in the container may be left on the ground for multiple uses, for an extended amount of time.

The mixture is effective in dry, wet, hot or cold weather as long as a stable attracting agent is used, like the peanut butter described above. Other attracting agents may be used as long as they do not decrease the desired SU of the mixture, or make the mixture hard to handle.

Without being limited to any particular theory, the composition of the present invention acts on the mucous membranes of the mammal. The mixture does not need to be sprayed on the object to be protected, or spread on the ground around the object to be protected. It is simply placed near or on the object to be protected. In addition, the embodiment of the composition is meant to be tasted by the mammal as the primary attractant. Finally, once the mammal has experienced the irritation from the mixture, it is not interested in investigating the contents of any nearby objects, and subsequently leaves the area. At least one embodiment of the composition and method of delivery provides an improved approach to keep mammals from damaging objects like garbage, flower beds, and the like.

The following examples provide illustrations of the use of embodiments of the invention.

### EXAMPLE 1

A composition was prepared according to the formula described above, with the attracting agent comprising approximately 95% of the mixture and the repelling agent comprising approximately 5% of the mixture. In this example, peanut butter was used as the attracting agent, and store-bought ground “cayenne” pepper was used as the repelling agent. This mixture was then placed in a small paper cup and placed outside at the residence of the author, on the ground next to the garbage the night before garbage pickup. This site was selected based on a history of garbage “attacks” by large raccoons or mammals present in the area. The mixture was partially consumed the first time it was placed near the garbage, but the garbage was untouched. The mixture was then left out for approximately one month, and the trash was never disturbed during that time. During this period, the trash across the street was knocked over, and showed evidence that a mammal had foraged through the contents.

Additionally, this same mixture was used to repel mammals that were digging up the author's garden. The composition was placed in small cups and positioned in the four corners of the garden. The first day the composition was present, a mammal or raccoon consumed the mixture in one cup, but ignored the other cups. Since that day the garden has not been disturbed.

The peanut butter initially attracted the raccoon or mammal, and once consumed, the cayenne pepper repelled the raccoon or mammal. It is surmised, that in addition to the repelling effect, the mammal learns to avoid the container based on its prior experience with the repelling agent.

### EXAMPLE 2

The same experiment as described in Example 1 was performed for a different location in the same town, with similar results. Each time the composition was included with the garbage, it repelled mammals from the trash. When the composition was not included, the garbage was disturbed.

I claim:

1. A composition to attract then repel mammals from an object or area comprising:
a) between 50.00% and 99.99% attracting agent, and
b) between 0.01%-50.00% repelling agent.

2. The composition of claim 1 wherein said attracting agent is edible.

3. The composition of claim 1 wherein said repelling agent comprises capsaicin.

4. The composition of claim 3 wherein said capsaicin has a minimum of 2,000 scoville heat units.

5. A method of delivery of composition of claim 1 comprising:
a) depositing said composition in an open-ended container, or on a transportable flat surface;
b) locating said open-ended container or said transportable flat surface near an object, on an object, near an area or within an area;
c) whereby keeping said mammals from disturbing or damaging said object or said area.
